(19) United States
(12) Patent Application Publication
(10) Pub. No.: US 2024/0256731 A1
(43) Pub. Date: Aug. 1, 2024

(54) STATE TRANSITION MATRIX-BASED POWER SYSTEM SIMULATION

(71) Applicant: X Development LLC, Mountain View, CA (US)

(72) Inventors: Hamed Khalilinia, San Mateo, CA (US); Leo Francis Casey, San Francisco, CA (US)

(21) Appl. No.: 18/103,091

(22) Filed: Jan. 30, 2023

(51) Int. Cl. G06F 30/20; G06F 30/18

(52) U.S. Cl. CPC G06F 30/20; G06F 30/18; G06F 2113/04; G06F 2119/06

(57) ABSTRACT

Methods, systems, and apparatus, including medium-encoded computer program products, for simulating an electrical power grid. One of the methods includes: receiving data describing an electric circuit of an electrical power grid, the electric circuit having nodes and branches between the nodes; generating a representation of the electrical power grid in a state-space form, the representation including one or more network equations that include a plurality of state variables each representing a respective independent storage element of in the electric circuit; generating, based on the representation of the electrical power grid in a state-space form, a model of the electrical power grid; and executing a simulation of electric power grid behaviors by using the model.

### BACKGROUND

Electrical power grids transmit electrical power to loads such as residential and commercial buildings. Virtual models of an electrical grid can be used to simulate operations under various conditions. The complexity of modern electric grids due to increased use and distribution of renewable energy sources necessitates increased complexity in electric grid models and simulations. New simulation processes are needed in order to accurately and efficiently simulate such complex models.

### SUMMARY

This specification relates to improved simulation performance of electrical power grids. An electrical power grid includes one or more sources of electricity, one or more loads, and mechanisms for distributing electrical power from the sources to the loads. The simulation may be performed in the form of transient analysis for user defined time range. During the transient analysis each time dependent electrical element is discretized at each simulation time step. The transient analysis of each electric circuit provides one or more matrices of linear and/or nonlinear equations, which can be numerically or analytically solved for the state variables (e.g., voltages or currents at selected nodes) at each simulation time step.

Particular embodiments of the subject matter described in this specification can be implemented so as to realize one or more of the following advantages. During the process of developing or maintaining an electric power grid, the behavior of the grid is often simulated to verify correct behavior prior to installation of new assets or modifications to existing assets of the grid, thereby reducing the likelihood that errors related to the installations or modifications are introduced into the grid. The techniques described below can be used to more efficiently simulate the behavior of the electric power grid, such as transient stability of the grid.

Specifically, using the techniques described in this specification, the computations—including computations for state-space equations that define a state-transition model of the grid—required during the process of electrical power grid simulation are executed efficiently using a parallel processing device. Thus, electrical power grid simulation can be executed more quickly because the computations can be efficiently parallelized. Simulating the behavior of the electrical power grid may therefore require fewer computational resources, e.g., reduced processor cycles, reduced wall clock time, reduced power consumption, and the computational efficiency of simulation process is therefore improved while overall simulation accuracy is maintained.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example simulation system.

FIG. 2 shows an example illustration of an electrical power grid.

FIG. 3 shows a diagram of an example electric circuit of an electrical power grid.

FIG. 4 is a flow diagram of an example process for simulating an electrical power grid.

FIGS. 5A-B show example illustrations of applying a sequence of simplification steps on the electric circuit of FIG. 3.

FIG. 6 shows a diagram of an example simplified electric circuit.

FIG. 7 shows an example first order matrix differential equation.

Like reference numbers and designations in the various drawings indicate like elements.

### DETAILED DESCRIPTION

Electrical power grids include a broad range of interconnected components that can be organized into two broad categories: transmission components that deliver power from power generation along high voltage wires across long distances to substations, and distribution components that distribute power from substations to endpoints such as homes and businesses. Some elements, such as substations, participate in both transmission and distribution. The components can be of various types such as inverters (Solar, Wind, HVDC, etc.), relays, Power Plant Controllers (PPCs), Energy Management Systems, Remedial Action Systems (RAS), Automatic Generator Controls, alarm systems and so on. The operation of one component often influences the operation of other components. For example, a PPC regulates and controls networked inverters within a power plant. In addition, various components can operate differently under different load conditions. Further, the output of one component can influence the load of other components. Understanding how the totality of components in the grid operate can aid in proper grid operation.

An electrical power grid can undergo additions and changes on a continual basis. New buildings, renewable power plants, stationary storage, mobile storage, and expansions to existing buildings, facilities, and loads are some examples of potential changes that can be proposed and made to existing electrical distribution feeders. Before new devices and systems are connected to the electrical power grid, it is often necessary to receive permission from the grid operator for the proposed changes. The grid operator ensures that the proposed changes are not likely to cause operation of the electrical distribution feeder to violate any limits or metrics that are put in place to ensure safe and reliable operation of the electrical power grid.

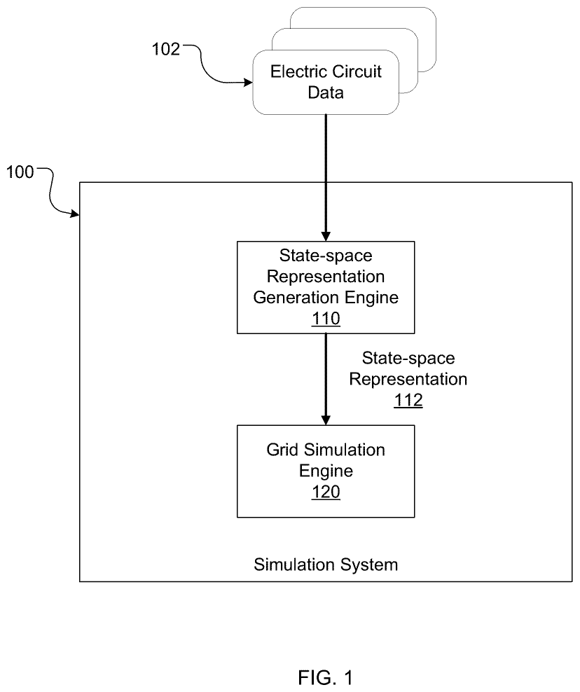

FIG. 1 shows an example electrical power grid simulation system 100. The electrical power grid simulation system 100 is an example of a system implemented as computer programs on one or more computers in one or more locations, in which the systems, components, and techniques described below can be implemented.

The electrical power grid simulation system 100 is a system that obtains electric circuit data 102 that describes an electric circuit of an electrical power grid and uses the electric circuit data 102 to execute a simulation of electrical power grid behaviors by using a model of the electrical power grid generated from the obtained electric circuit data 102. The electric circuit data 102 can be any machine-readable description of an electric circuit. For example, the electric circuit data 102 can include textual data indicative of a text-format language, image data indicative of a graphical representation, or both that describes the electric circuit.

In particular, the electric circuit data 102 can describe one or more elements (or components) of the electric circuit. As described above, the elements can include substation transformers, distribution switches and reclosers, voltage regulation schemes, e.g., tapped magnetics or switched capacitors, network transformers, load transformers, inverters, generators, and various loads (e.g. households). The electric circuit data 102 can include descriptions of elements that connect elements, such as wires or power lines. For such connection elements, the electric circuit data 102 can include a description of the elements connected by the connection element, and a description of the connection elements that are connected by the connection element.

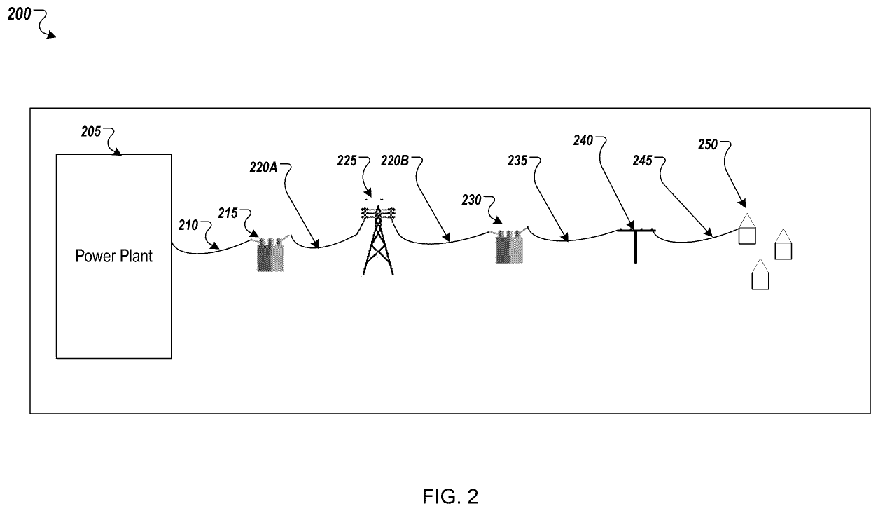

FIG. 2 shows an example illustration 200 of an electrical power grid. In this example, the electrical power grid includes a power plant 205 that houses one or more generators and that is connected by a high voltage power line 210 to a distribution substation 215. The voltage of the output from the power plant 205 is stepped up for transmission on the high voltage power line 210. The distribution substation 215 is connected to a second substation 230 by high voltage power lines 220A, 220B that span a transmission tower 225. The second substation 230 can include a transformer that reduces voltage before delivering electricity across lower voltage power lines 235, 245 that span utility poles 245 and are connected to end loads 250 such as homes, apartments, businesses, etc.

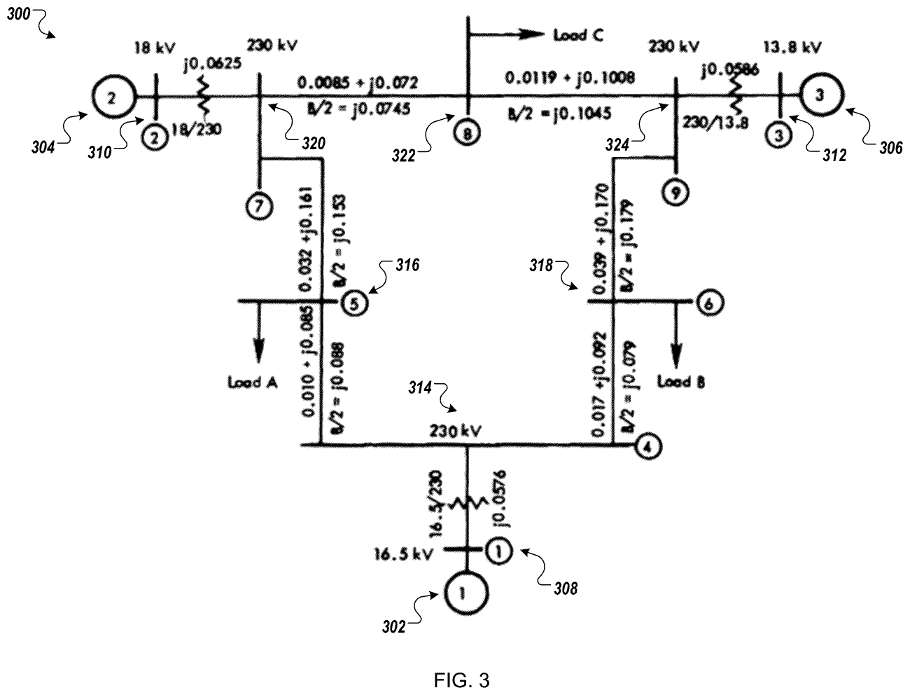

FIG. 3 shows a diagram 300 of an example electric circuit representation of an electrical power grid. In this example, the electrical power grid is illustrated as a Western System Coordinating Council (WSCC) 3-phase, 9-bus symmetric power system that receives power from three generators. The generators can be synchronous generators, induction generators, or any other type of generator. The generators can include turbines that are driven by one or more sources, such as wind, water, steam, or gas. The generators 302, 304, and 306 provide electrical power to nine electrical buses 308, 310, 312, 314, 316, 318, 320, 322, and 324, which in turn provide electrical power to various electrical loads, e.g., loads A, B, and C, that are connected to the electrical power grid. In FIG. 3, the double circuit transmission line parameters are numerically shown in the form of R+jX(jB/2), where R, X, and B represent resistance, reactance, and susceptance, respectively, per phase with two lines.

The system 100 can receive the electric circuit data 102 in any of a variety of ways. For example, the system 100 can receive electric circuit data as an upload from a remote user of the system over a data communication network, e.g., using an application programming interface (API) made available by the system 100. As another example, the system 100 can receive an input from a user specifying which data that is already maintained by the system 100 at another system that is accessible by the system 100 should be used as the electric circuit data.

The electrical power grid simulation system 100 includes a state-space representation generation engine 110 and a grid simulation engine 120.

The state-space representation generation engine 110 implements software that when executed processes the electric circuit data 102, data derived from the electric circuit data 102, or both to generate a representation 112 of the electrical power grid in a state-space form. The state-space representation 112 a software representation of electrical networks and electrical power grid components described by the electric circuit that includes mathematical representations of the components used for simulation and analysis.

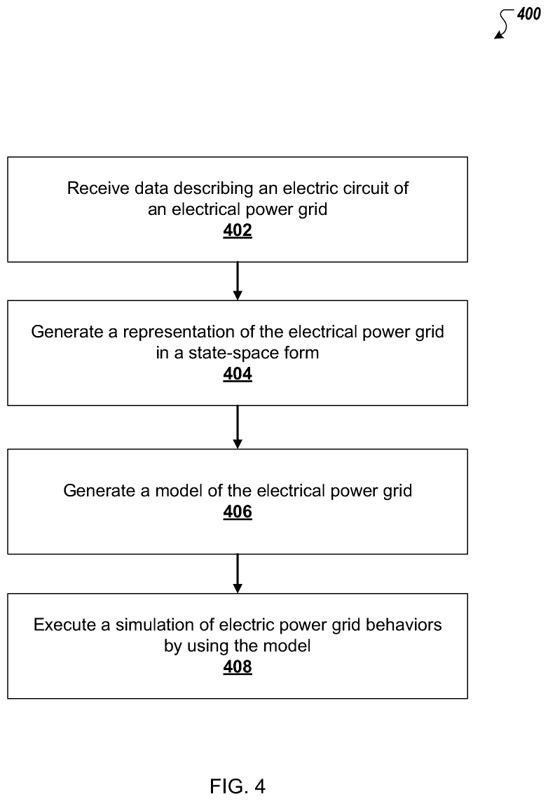

In particular, the state-space representation 112 includes a set of network equations and a set of generator/load equations. The set of network equations includes one or more capacitor state-space equations and one or more inductor state-space equations, where each equation includes one or more state variable each representing a respective independent storage element, i.e., a respective capacitor or inductor, in the electric circuit. The set of load/generator equations includes one or more controlled current source state-space equations and/or one or more controlled voltage source state-space equations. Each controlled current source equation can include one or more input variables each representing a respective load in the electric circuit. Each controlled voltage source equation can include one or more input variables each representing a respective generator in the electric circuit. To generate this representation 112 of the electrical power grid in the state-space form, the state-space representation generation engine 110 performs a sequence of simplification steps on the electric circuit, as discussed in more detail below with reference to FIGS. 4-6.

The grid simulation engine 120 is configured to generate a software model of the electrical power grid from the state-space representation 112 and execute a simulation of electric power grid behaviors by using the model. The software model can be a state-transition matrix model. The state-transition matrix model can simulate the dynamics of operating the electrical power grid by evaluating a first order matrix differential equation in the form of:

$$\dot{X} = AX + {BU}_{in} ,$$

where
X is an n×1 state vector of n state variables, A is an n×n state-transition matrix, B is an n×m input matrix, Uᵢₙ is a m×1 input vector of m input variables, and entries of the state vector X, state-transition matrix A, input matrix B, and input vector Uᵢₙ can generally be determined from the variables and coefficients in set of network equations and the set of generator/load equations. The state-transition matrix A is a matrix whose product with the state vector X at an initial time t gives state vector X at a later time t=t+1. Thus, during the simulation process, the grid simulation engine 120 can represent the status of the electrical power grid at a given time as a state determined by using the state-transition matrix A.

For example, the state-transition matrix model can be generated in a Simscape™ environment, or another industrial grade numerical simulation environment, such as a PowerWorld® environment or a Power System Simulation for Engineering® (PSS/E) environment. For example, the simulation of electric power grid behaviors can be used to conduct transient stability analysis or load flow analysis of the electrical power grid, instead of or in addition to other techniques for examining the characteristics of the various components of an electrical power grid.

By virtue of being generated from the set of network and generator/load equations which are functions of state variables or input variables independent from one another, the execution of the state-transition matrix model can be executed more efficiently using a parallel processing device than conventionally possible. In particular, the electrical power grid simulation system 100 can partition the computations, e.g., matrix or vector multiplications and summations, of set of the equations among the available multipliers and adders of the parallel processing device and execute computations of two or more of the equations in the set in parallel. In some implementations, the computations are performed on one parallel processing device, while in some other implementations, the operations are performed on one or more different parallel processing devices that communicate with each other, e.g., over a communication link that is established between the different devices. The parallel processing device can be, for example, a graphics processing unit (GPU), a tensor processing unit (TPU), an Edge TPU, a multicore CPU, or any other appropriate processing device that can execute multiple operations in parallel.

Parallelization provides several computing advantages. The processing time for executing a simulation is reduced for a given electrical power grid. For example, performing transient stability analysis of the electrical power grid using the state-transition model can be executed more quickly because the computations of the set of network and generator/load equations can be efficiently parallelized.

The electrical power grid simulation system 100 can be used, for example, by grid operators, e.g., utilities. The system can also be used by project developers, property owners, construction companies, and any other involved parties having interest in making additions and/or changes to an electrical power grid.

For example, prior to permitting installation of an interconnection, a grid operator can use the system 100 to simulate electrical grid operation with the proposed interconnection. The system can perform interconnection analysis over a range of conditions and output results including providing a pass/fail verdict for multiple metrics. Based on results of the simulation, the grid operator can determine whether to approve, deny, or modify the proposed interconnection.

FIG. 4 is a flow diagram of an example process 400 for simulating an electrical power grid. For convenience, the process 400 will be described as being performed by a system of one or more computers located in one or more locations. For example, a neural architecture search system, e.g., the electrical power grid simulation system 100 of FIG. 1, appropriately programmed, can perform the process 400.

The system receives data describing an electric circuit of an electrical power grid (step 402). An electrical power grid generally includes a set of buses to which generators and loads are connected, and transmission lines that connect these buses. When represented as an electric circuit, each bus may correspond to a respective node (a junction where two or more elements connect), and each transmission line may correspond to a respective branch (a connection between nodes) in the electric circuit.

The system generates a representation of the electrical power grid in a state-space form by performing a sequence of simplification steps on the electric circuit (step 404).

In some case, to provide a more generalized form of the representation, the system can generate the representation of the electrical power grid by placing a controlled voltage source on each branch and a controlled current source on each node. If there is no generator on the branch, or no load on the node, then the equivalent voltage or current source would be set to inject zero values to the electrical power grid.

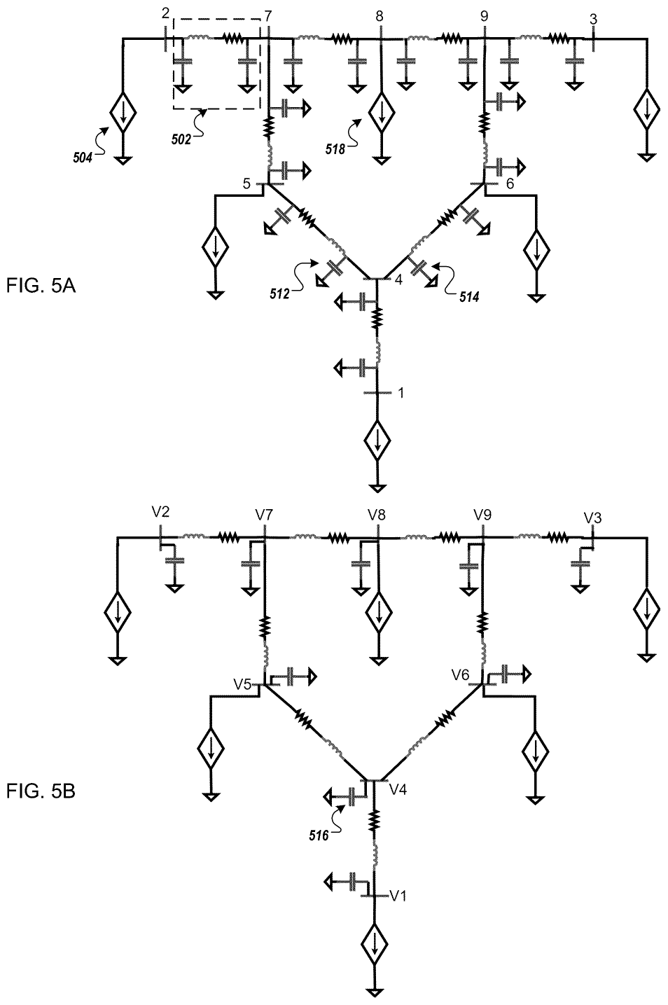

FIGS. 5A-B and 6 show example illustrations of applying a sequence of simplification steps on the electric circuit of FIG. 3. As shown in FIG. 5A, the sequence of simplification steps can include replacing transmission lines with PI sections (e.g., PI section 502). The sequence of simplification steps can include replacing a load with one or more elements that collectively define an equivalent impedance value, or with a controlled voltage or current source (e.g., controlled current source 518). The sequence of simplification steps can also include replacing a generator with a controlled current or voltage source (e.g., controlled current source 504).

As shown in FIG. 5B, the sequence of simplification steps can include removing additional capacitor elements between each node to ground, and removing additional inductors on each branch from the electric circuit representation of the power grid. In this way, the system ensures that there is only one capacitor element represented between on each node and a respective electrical ground, and that there is only one inductor element represented on each branch in the simplified electric circuit. For example, capacitors 512 and 514 in the electric circuit of FIG. 5A are pruned to ensure that the electric circuit of FIG. 5B has at least one and only one capacitor 516 between the node corresponding to bus 4 to ground.

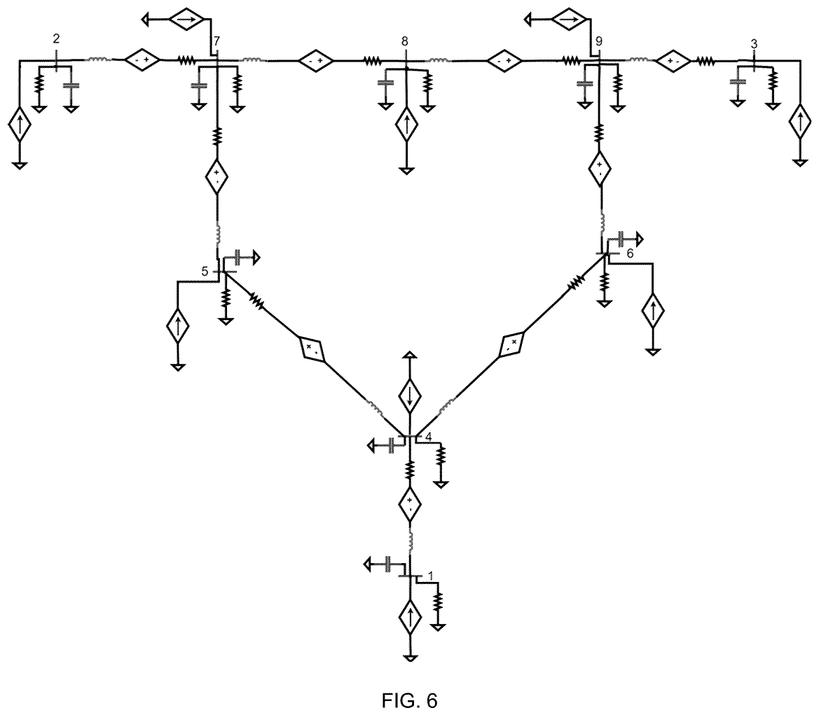

FIG. 6 shows a diagram of an example simplified electric circuit. In particular, FIG. 6 shows an example simplified electric circuit having the final form based on which the state-space representation will be generated. As illustrated, in some cases the simplified electric circuit can additionally include one or more shunt resistors (which may be set to have a small resistance value), one or more controlled voltage or current sources (which may be set to have zero values), or both. When included, these additional elements may allow for more accurate simulation of the real electrical power grid system.

The system then generates the representation of the electrical power grid in the state-space form, from the simplified electric circuit. The state-space representation includes a set of network equations and a set of generator/load equations. The set of network equations includes one or more capacitor state-space equations and one or more inductor state-space equations, where each equation includes one or more state variable each representing a respective independent storage element in the electric circuit. Specifically, each independent storage element can be a respective capacitor or inductor, and the corresponding state variable can have a value that defines a voltage value of the capacitor or a current value of the inductor.

In some implementations, the system can generate the one or more capacitor state-space equations by applying Kirchhoff's current law (KCL) on the nodes of the simplified electric circuit. Kirchoff's current law (KCL) states that for any node in an electric circuit, the sum of currents entering the node is equal to the sum of currents exiting the node. KCL allows for defining an equation that sets the total sum of currents (positive for incoming currents, negative for outgoing currents) equal to zero. In these implementations, the number of capacitor state-space equations can thus be the same as the number of nodes in the simplified electric circuit (which may further be the same as the number of buses in the electrical power grid).

In some implementations, the system can generate the one or more inductor state-space equations by applying Kirchhoff's voltage law (KVL) on the branches of the simplified electric circuit. Kirchoff's voltage law (KVL) states that for any loop in an electric circuit, the sum of voltages must be equal to zero. A loop is any closed path going through circuit elements. KVL allows for defining an equation that sets the total sum of voltages in a loop (positive for voltage ‘drops’ across circuit elements like resistors, capacitors, or inductors, negative for voltage sources like generators) equal to zero.

The set of load/generator equations includes one or more controlled current source state-space equations and/or one or more controlled voltage source state-space equations, where each controlled current source equation includes one or more input variables each representing a respective load in the electric circuit, and each controlled voltage source equation includes one or more input variables each representing a respective generator in the electric circuit.

In some implementations, the system generates the set of load/generator equations by using cut-set techniques. For example every node in the electric circuit can define a cut-set, in that the cut-set divides the electric circuit into two distinct parts. In these implementations, the system can generate one load/generator equation for each node in the simplified electric circuit.

Continuing with the example of FIGS. 3, 5A-B and 6, some of the example capacitor state-space equations include:

$$\begin{matrix}\dot{υ 1} = - \frac{S 10}{C 10} υ 1 - \frac{1}{C 10} i 14 + \frac{1}{C 10} I 1 \\ \dot{υ 2} = - \frac{S 20}{C 20} υ 2 - \frac{1}{C 20} i 27 + \frac{1}{C 20} I 2 \\ \dot{υ 3} = - \frac{S 30}{C 30} υ 3 - \frac{1}{C 30} i 39 + \frac{1}{C 30} I 3 \\ \dot{υ 4} = - \frac{S 40}{C 40} υ 4 - \frac{1}{C 40} ( - i 14 + i 46 + i 45 ) + \frac{1}{C 40} I 4 \\ \cdot \\ \cdot \\ \cdot \end{matrix}$$

Some of the example inductor state-space equations include:

$$\begin{matrix}\dot{i 14} = - \frac{R 14}{L 14} i 14 - \frac{1}{L 14} ( υ 1 - υ 4 ) + \frac{1}{L 14} V 14 \\ \dot{i 45} = - \frac{R 45}{L 45} i 45 - \frac{1}{L 45} ( υ 4 - υ 5 ) + \frac{1}{L 45} V 45 \\ \cdot \\ \cdot \\ \cdot \end{matrix}$$

And some of the example controlled current or voltage source state-space equations include:

$$\begin{matrix}\dot{I 1} = f 1 ( I 1 , X 1 , X ) \\ \dot{X 1} = f 1 ( I 1 , X 1 , X ) \\ \dot{I 2} = f 2 ( I 2 , X 2 , X ) \\ \dot{X 2} = f 2 ( I 2 , X 2 , X ) \\ \cdot \\ \dot{V 14} = f 3 ( V 14 , X 14 , X ) \\ \dot{X 14} = f 3 ( V 14 , X 14 , X ) \\ \cdot \end{matrix}$$

In the example equations above, R, L, C, and S refers to resistance, inductance, capacitance, and conductance of an element, respectively, with the integers in subscript indicating the two neighboring nodes of the element. R, L, C, and S thus each denotes a constant. Capitalized letters I and V denote input variables the exact values of which may change over time, and non-capitalized letters i and v denote state variables. X denotes the state vector, i.e., a vector of the state variables. For example, X1 is a vector of generator state variables, and X14 is a vector of load state variables.

The system generates, based on the representation of the electrical power grid in a state-space form, a model of the electrical power grid (step 406). As described above, the model can be a state-transition matrix model, which simulates the dynamics of operating the electrical power grid by evaluating a first order matrix differential equation in the form of:

$$\dot{X} = AX + {BU}_{in} .$$

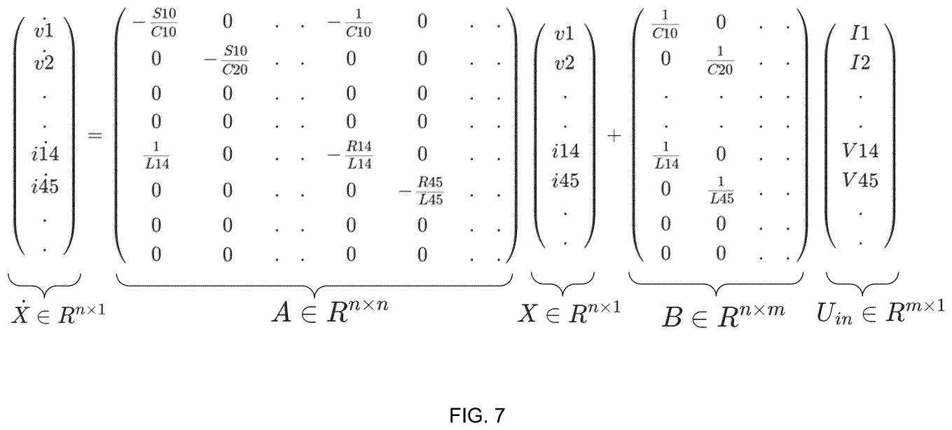

FIG. 7 shows an example first order matrix differential equation used in the state-transition matrix model. As shown, entries of the state vector X, state-transition matrix A, input matrix B, and input vector Uᵢₙ can generally be determined from the variables and coefficients in set of network equations and the set of generator/load equations, the examples of which are mentioned above.

The system executes a simulation of electric power grid behaviors by using the model (step 408), which can be a state-transition matrix model. During simulation, the set of network equations and the set of generator/load equations can be numerically or analytically solved for the state variables (e.g., voltages or currents at selected nodes) at each simulation time step.

For example, the system can execute a transient stability simulation of the electrical power grid described in the received data by using the model. Transient stability concerns the rotor angle stability for short-term dynamics and describes the ability of a grid to retain synchronism after a large disturbance occurs. Synchronicity of electrical power grids means that the resulting angular difference between all its generators remains within certain bounds after such a large disturbance, which are usually called contingencies and include for example different types of short circuits or the loss of generation and load buses.

In some implementations, the system can then output the results of the simulation, e.g., data characterizing the time-domain simulation results, e.g., time-domain voltage, current, and active/reactive power responses. For example, the system can output the results of the simulation to the user that submitted the electric circuit data.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a JAX framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. An electrical power grid simulation method comprising:
receiving data describing an electric circuit of an electrical power grid, the electric circuit having nodes and branches between the nodes;
generating a representation of the electrical power grid in a state-space form, the representation including one or more network equations that include a plurality of state variables each representing a respective independent storage element of in the electric circuit, and wherein generating the representation of the electrical power grid in the state-space form comprises:
generating a simplified electric circuit which has only one capacitor element between each node to ground, and has only one inductor element on each branch; and
generating, from the simplified electric circuit, the representation of the electrical power grid in the state-space form; and
generating, based on the representation of the electrical power grid in a state-space form, a model of the electrical power grid.

2. The method of claim 1, further comprising:
executing a simulation of electric power grid behaviors by using the model.

3. The method of claim 2, wherein executing the simulation of electric power system behaviors by using the model comprises:
executing a transient stability simulation of the electric power system by using the model to analyze the stability of the electrical power grid described in the received data.

4. The method of claim 1, wherein the independent storage element of in the electric circuit is a capacitor or an inductor.

5. The method of claim 4, wherein each state variable represents a voltage value of the capacitor or a current value of the inductor.

6. The method of claim 1, wherein generating the simplified electric circuit comprises:
removing, from the electric circuit of the electrical power grid described in the received data, any additional capacitor elements between each node to ground; and
removing, from the electric circuit of the electrical power grid described in the received data, any additional inductor elements on each branch.

7. The method of claim 1, wherein generating the representation of the electrical power grid in the state-space form comprises:
generating a set of capacitor state-space equations by applying Kirchhoff's current law (KCL) on the nodes of the simplified electric circuit.

8. The method of claim 1, wherein generating the representation of the electrical power grid in the state-space form comprises:
generating a set of inductor state-space equations by applying Kirchhoff's voltage law (KVL) on the branches of the simplified electric circuit.

9. The method of claim 1, wherein generating the simplified electric circuit comprises:
replacing a load with one or more elements that define an equivalent impedance value; and
replacing a generator with a controlled current or voltage source.

10. The method of claim 9, wherein generating the representation of the electrical power grid in the state-space form comprises:
generating a set of controlled current source state-space equations using cut-set techniques.

11. The method of claim 1, wherein the electrical power grid is a three-phase symmetric system.

12. A system comprising one or more computers and one or more storage devices storing instructions that when executed by the one or more computers cause the one or more computers to perform electrical power grid simulation operations comprising:
receiving data describing an electric circuit of an electrical power grid, the electric circuit having nodes and branches between the nodes;
generating a representation of the electrical power grid in a state-space form, the representation including one or more network equations that include a plurality of state variables each representing a respective independent storage element of in the electric circuit, and wherein generating the representation of the electrical power grid in the state-space form comprises:
generating a simplified electric circuit which has only one capacitor element between each node to ground, and has only one inductor element on each branch; and
generating, from the simplified electric circuit, the representation of the electrical power grid in the state-space form; and
generating, based on the representation of the electrical power grid in a state-space form, a model of the electrical power grid.

13. The system of claim 12, wherein the operations further comprise:
executing a simulation of electric power grid behaviors by using the model.

14. The system of claim 13, wherein executing the simulation of electric power system behaviors by using the model comprises:
executing a transient stability simulation of the electric power system by using the model to analyze the stability of the electrical power grid described in the received data.

15. The system of claim 12, wherein the independent storage element of in the electric circuit is a capacitor element or an inductor element.

16. The system of claim 15, wherein each state variable represents a voltage of the capacitor element or a current value of the inductor element.

17. The system of claim 12, wherein generating the simplified electric circuit comprises:
removing, from the electric circuit of the electrical power grid described in the received data, any additional capacitor elements between each node to ground; and
removing, from the electric circuit of the electrical power grid described in the received data, any additional inductor elements on each branch.

18. The system of claim 12, wherein generating the representation of the electrical power grid in the state-space form comprises:
generating the set of capacitor state-space equations by applying Kirchhoff's current law (KCL) on the nodes of the simplified electric circuit.

19. The system of claim 12, wherein generating the representation of the electrical power grid in the state-space form comprises:
generating the set of inductor state-space equations by applying Kirchhoff's voltage law (KVL) on the branches of the simplified electric circuit.

20. One or more non-transitory computer-readable storage media storing instructions that when executed by one or more computers cause the one or more computers to perform electrical power grid simulation operations comprising:
receiving data describing an electric circuit of an electrical power grid, the electric circuit having nodes and branches between the nodes;
generating a representation of the electrical power grid in a state-space form, the representation including one or more network equations that include a plurality of state variables each representing a respective independent storage element of in the electric circuit, and wherein generating the representation of the electrical power grid in the state-space form comprises:
generating a simplified electric circuit which has only one capacitor element between each node to ground, and has only one inductor element on each branch; and
generating, from the simplified electric circuit, the representation of the electrical power grid in the state-space form; and
generating, based on the representation of the electrical power grid in a state-space form, a model of the electrical power grid.
